(19) United States
(12) Patent Application Publication
(10) Pub. No.: US 2021/0176251 A1
(43) Pub. Date: Jun. 10, 2021

(54) Access Control Method and Industrial Network Using a Blockchain for Access Control

(71) Applicant: Siemens Aktiengesellschaft, Muenchen (DE)

(72) Inventors: Artem Vladimirovich Ozhigin, St. Petersburg (RU); Sergey Pavlovich Sobolev, Saint-Petersburg (RU)

(21) Appl. No.: 16/616,845

(22) PCT Filed: May 30, 2017
(86) PCT No.: PCT/RU2017/000371

§ 371 Date: Nov. 25, 2019

(51) Int. Cl. H04L 29/06; H04L 9/32; H04L 9/06

(52) U.S. Cl. CPC H04L 63/10; H04L 9/3247; H04L 2209/56; H04L 2209/38; H04L 9/0618

(57) ABSTRACT

An access control method and industrial network for field automation which includes a plurality of network nodes that host a blockchain storing a plurality of confirmed transactions, exchange an unconfirmed transaction and add the unconfirmed transaction to the blockchain as a confirmed transaction of the confirmed transactions only if a consensus is reached between the plurality of network nodes, wherein the plurality of network nodes include a trusted backbone of the industrial network, and the confirmed transactions stored by the blockchain include a confirmed connection transaction that is authorized by the trusted backbone, indicative of a connecting device and descriptive of a right of the connecting device to access the industrial network, where a provider network node grants a connecting device access to a network resource if the confirmed connection transaction is stored in the blockchain and an amount of cryptocurrency is transferred to the provider network node.

### CROSS-REFERENCE TO RELATED APPLICATIONS

This is a U.S. national stage of application No. PCT/RU2017/000371 filed May 30, 2017.

### BACKGROUND OF THE INVENTION

### 1. Field of the Invention

The present invention relates to industrial field automation and, more particularly, to an industrial network comprising a plurality of network nodes and an access control method for the same.

### 2. Description of the Related Art

Industrial networks for field automation typically use industry standard connections, such as Ethernet, to interconnect a plurality of control units. The industrial network may cover a large area where physical access control is impossible to achieve. It may therefore be easy for an intruder to go to a remote location and join a portable computer to the industrial network. It is desirable to perform computational access control to prevent an intruder from gaining access to the industrial network, but allow a legitimate maintenance device to join the industrial network at the remote location. This can conventionally be achieved using a virtual private network (VPN). However, once an intruder manages to enter the VPN, the intruder will have full access to the network. Once this happens, it is difficult to know which control units were compromised by the intruder. Further, a centralized authentication database can be used to implement credential based access. However, in this case, if connectivity with the centralized authentication database is temporarily lost due to a network error, it may be impossible to connect a legitimate maintenance device at the remote location for diagnosis.

### SUMMARY OF THE INVENTION

It is an object of the present invention to provide secure and resilient access control for an industrial network.

This and other objects and advantages are achieved in accordance with the invention by an industrial network comprising a plurality of network nodes, where the plurality of network nodes are interconnected and are configured to host a blockchain. The blockchain is a distributed permissionless trusted database configured to store a plurality of confirmed transactions. The plurality of network nodes are further configured to exchange an unconfirmed transaction among each other, and to add the unconfirmed transaction to the blockchain as a confirmed transaction of the plurality of confirmed transactions only on the condition that a consensus determined by a consensus protocol of the blockchain is reached between the plurality of network nodes. The plurality of network nodes further include a plurality of trusted network nodes forming a trusted backbone of the industrial network. The confirmed transactions stored by the blockchain comprise a confirmed connection transaction that is authorized by the trusted backbone, is indicative of a connecting device and is descriptive of a right of the connecting device to access the industrial network.

A “network node”, as used herein, may refer to any unit that is configured to participate in the hosting of the blockchain. A network node may be established in software and/or hardware. In particular, a network node may be implemented using, for example, a control unit of the industrial network, an embedded device, a personal computer device, a server computer device, or an application specific integrated circuit device. Each respective unit or device may implement one or more network nodes.

The plurality of network nodes may be interconnected using any suitable connection technology like, for example, Ethernet, Fieldbus, EtherCAT, Wi-Fi, Bluetooth, and in any suitable topology, including a star topology, a line topology, a mesh topology or a random topology.

A “transaction”, as used herein, may refer to any sequence of data. In other words, the semantics of a transaction depends on how the transaction is interpreted by a network node when referring to the contents of the transaction. In particular, hereinbelow, different possible semantics of transactions stored in the blockchain will be described.

A transaction is referred to as a “confirmed transaction” if it is stored by the blockchain, and is referred to as an “unconfirmed transaction”, if it is not, or not yet, stored by the blockchain.

The plurality of network nodes may exchange the unconfirmed transaction among each other in a peer-to-peer manner, where each of the plurality network nodes is aware of how to reach at least one further network node, but may not be aware of how to reach all of the plurality of network nodes. The unconfirmed transaction may be passed on from network node to network node until it ultimately disseminates over the entire network.

The blockchain is a distributed permissionless trusted database. The blockchain may store the plurality of confirmed transactions as a linked chain of blocks, where each block comprises at least one of the plurality of confirmed transactions. The blockchain may be distributed over the plurality of network nodes, i.e., for example, the plurality of network hosts may host the blockchain by each of the plurality of network hosts storing, in a storage included in each of the network hosts, a copy of the linked chain of blocks. The blockchain may be permissionless in a sense that no credentials, such as username and password, are required to read a transaction from the blockchain or to add a transaction to the blockchain.

The consensus protocol of the blockchain may be configured such that adding an unconfirmed transaction exchanged between the plurality of network nodes to the plurality of confirmed transactions stored in the blockchain requires an amount of computing resources to be allocated, used or spent, thereby making it difficult for intruders to introduce malicious transactions into the blockchain. Computing resources, as used herein, may be, for example, computing power, storage space or cryptocurrency amounts.

The consensus protocol may, in particular, be configured such that an intruder using a malicious network node and trying to add a malicious unconfirmed transaction into the blockchain, and/or to manipulate an existing confirmed transaction stored by the blockchain, would have to allocate, use or spend a similar or higher amount of computing resources as the combined computing resources of all legitimate network nodes participating in reaching the consensus, in order for the plurality of network nodes to reach the consensus to add the malicious unconfirmed transaction as a confirmed transaction to the blockchain. The consensus protocol may thus be regarded as the source of trust in the contents of the transactions stored by the distributed database constituted by the blockchain in spite of the absence of trust in at least some of the network nodes.

In other words, even if the industrial network comprises, among the plurality of network nodes, at least one malicious network node that has been joined to the network by an intruder, the blockchain may still be able to serve as a trusted database.

The confirmed transactions stored by the blockchain comprise a confirmed connection transaction. The term “connection transaction”, herein, is used to describe a transaction with a specific semantics, i.e., a transaction comprising data that is indicative of a connecting device and descriptive of a right of the connecting device to access the industrial network.

A connecting device, herein, may refer to any device that is seeking to join and access the industrial network. For example, the connecting device may be a device seeking to access a resource provided by the industrial network. For example, the connecting device may be a portable computer operated by a maintenance operator. The maintenance operator may join the portable user to the industrial network at a remote location and use it to try to gain access to a remote control unit of the industrial network.

By storing, in the blockchain, data indicative of a connecting device and descriptive of a right of the connecting device to access the industrial network, any network node can refer to the blockchain to determine whether a connecting device seeking to access a resource provided by the network node has been granted the right to do so. That is, for example, the remote control unit of the industrial network may comprise a network node that is configured to refer to the blockchain to determine whether the portable computer is a legitimate maintenance device.

In this way, the industrial network in accordance with the invention can implement computational access control based on the contents of the confirmed connection transactions stored in the blockchain. As noted above, the blockchain is a database that is trusted in spite of the absence of trust in any particular network node of the industrial network. That is, the connection transactions stored in the blockchain are trusted and safeguarded from manipulation even if one or more malicious network nodes are connected to the industrial network. The security of the computational access control to the resources provided by the industrial network is thus improved.

The industrial network in accordance with the invention further comprises a trusted backbone comprised by a plurality of trusted network nodes. A trusted network node may be a network node that is located in one or more areas, such as one or more safe rooms, which can be secured with physical access controls, and/or a node that is only accessible to trusted operators of the industrial network.

The trusted backbone may be used to decide which connecting devices are granted access to the industrial network. In other words, the trusted backbone may be configured to create a connection transaction. That is, decisions taken by the trusted backbone may be represented in the blockchain by the confirmed connection transaction stored in the blockchain. The confirmed connection transaction stored in the blockchain is authorized by the trusted backbone. That is, the confirmed connection transaction may comprise authorization data created by the trusted backbone as a proof that the confirmed connection transaction is legitimate.

The trusted backbone may be advantageously used by the owner or operator of the industrial network to retain control over which connecting devices are granted the right to access the industrial network, while at the same leveraging the benefits of the blockchain as a distributed permissionless trusted database.

In accordance with an embodiment, the blockchain may store the plurality of confirmed transactions as a chain of blocks, where each block of the chain of blocks comprises one or more of the confirmed transactions, a hash value of the confirmed transactions comprised by the block and a reference value referring back to a previous block of the chain of blocks, thereby forming the chain of blocks.

The reference value referring back to the previous block of the chain of blocks may be a hash value of the entire data comprised by the previous block of the chain of block.

The hash value of the confirmed transactions comprised by the block may be a hash value or Merkle root of a Merkle tree of hash values of each confirmed transaction comprised by the block. In some embodiments, the hash value of the confirmed transactions comprised by the block may be a hash value of a list of the hash values of each confirmed transaction of the block, or a hash value of a concatenation of each confirmed transaction of the block.

For example, each hash value may be a value calculated by applying a hash function to a sequence data. The hash function may be selected such that it is computationally easy to calculate the hash value for a given set of sequence data, but it is computationally difficult to calculate a sequence of data for a given hash value. The hash function may be selected from one of the following: SHA-1, SHA-2, SHA-3, SHA256, SHA256d and a Keecak function.

The plurality of network nodes may be configured to add the unconfirmed transaction to the blockchain by appending a candidate block comprising multiple unconfirmed transactions including the unconfirmed transaction to the chain of blocks, whereby the candidate block becomes a block of the chain of blocks and the unconfirmed transactions comprised by the candidate block become confirmed transactions of the plurality of confirmed transactions.

The consensus to add unconfirmed transactions to the blockchain as the confirmed transaction may be a consensus to append the candidate block comprising the multiple unconfirmed transactions including the unconfirmed transaction to the chain of blocks.

The consensus to append the candidate block to the chain of blocks according to the consensus protocol of the blockchain may be achieved in the following way: Each of the plurality of network nodes may locally store one or more local chains of blocks, where one of the local chains of blocks is regarded by the respective network node as a true representation of the chain of blocks of the blockchain. At least some of the plurality of network nodes may be mining network nodes configured to form the candidate block from the multiple unconfirmed transactions. The plurality of network nodes may be configured to exchange the candidate block among each other. Each of the plurality of network nodes may be configured to add the exchanged candidate block to a respective local chain of blocks of the one or more local chains of blocks only if the exchanged candidate block comprises a proof of work being a proof of resources allocated, used or spent by the mining network node having formed the exchanged candidate block in forming the exchanged candidate block; and only if the reference value of the exchanged candidate block refers back to either the last block of the respective local chain of blocks, in which case the exchanged candidate block is appended to the respective local chain of blocks to become a new last block of the respective local chain of blocks; or to any other block of the respective local chain of blocks that is not the last block of the respective local chain of blocks, in which case the respective local chain of blocks is forked, thereby creating a further local chain of blocks, and the exchanged candidate block is appended to the further local chain of blocks to become a new last block of the further local chain of blocks. For each of the plurality of network nodes, if a plurality of local chains of blocks exist, then the longest local chain of blocks of the plurality of local chains of blocks may be regarded as the true representation of the chain of blocks of the blockchain, and any other local chain of blocks of the plurality of local chains of blocks may be discarded.

In some embodiments, the proof of work may be an arbitrary nonce value comprised by the candidate block and selected such that the hash value of the candidate block is smaller than a predetermined threshold.

It will be appreciated that due to the nature of the hash function, it is computationally difficult and will require computing resources such as processing power and time to select a proper nonce value.

In some embodiments, the exchanged candidate block may not be required to comprise a proof of work, and the amount of resources allocated, used or spent by the mining network node having formed the exchanged candidate block in forming the exchanged candidate block may be determined instead using a proof-of-stake, proof-of-burn, proof-of-activity or proof-of-raffle method.

By regarding only the longest chain of blocks as the true representation of the blockchain, where each block comprises a proof-of-work or other proof of computing resources allocated, used or spent, it is made prohibitively difficult, in terms of computing power and/or other computing resources that have to be allocated, used or spent, for a malicious intruder to manipulate data stored in the confirmed transactions in the blockchain and/or to add new malicious transactions to the blockchain.

Further, a respective network node stores a local chain of blocks. As a result, the blockchain is resilient even if a temporary loss of network connectivity occurs. When a connecting device connects to a remote network node in the industrial network, the remote network node may refer to the longest local chain of blocks to determine whether it comprises a confirmed connection transaction that is descriptive of the right of the connecting device to access the industrial network, even if some or all of the network connectivity has been temporarily lost.

In accordance with a further embodiment, the unconfirmed transaction is an unconfirmed connection transaction, the trusted backbone is configured to authorize the unconfirmed connection transaction, and the plurality of network nodes are further configured to reach the consensus to add the unconfirmed connection transaction to the blockchain as the confirmed connection transaction of the plurality of confirmed transactions only on the condition that the unconfirmed connection transaction is authorized by the trusted backbone.

The consensus protocol may require any unconfirmed transaction to fulfil a certain validity criterion for it to be added to the blockchain as a confirmed transaction of the plurality of confirmed transactions. The validity criterion may depend on the semantics of the respective transaction. If the unconfirmed transaction is an unconfirmed connection transaction, then the validity criterion for adding an unconfirmed connection transaction may, in accordance with the present embodiment, be that the unconfirmed connection transaction shall be authorized by the trusted backbone. That is, the unconfirmed connection transaction may be required to comprise authorization information created by a trusted network node of the trusted backbone.

In this way, even if a malicious network node exchanges a malicious unconfirmed connection transaction with the plurality of network nodes, the malicious unconfirmed connection transaction not being authorized by the trusted backbone, at least the non-malicious network nodes of the plurality of network nodes will adhere to the consensus protocol and not add the malicious unconfirmed connection transaction to the blockchain. The security of the computational access control implemented by the industrial network is thereby further improved.

The trusted backbone may be configured to authorize the unconfirmed connection transaction only if the unconfirmed connection transaction has been initiated by a node of the trusted backbone. For example, any of the trusted network nodes may only authorize an unconfirmed connection transaction that has been initiated by the respective node. In this way, it is ensured that only the trusted network node can create a valid unconfirmed connection transaction. In other words, only trusted operators of the trusted network node will be able to have an unconfirmed connection transactions descriptive of the right to access the industrial network be added to the blockchain as the confirmed connection transaction.

In accordance with a further embodiment, the plurality of network nodes further comprise a provider network node configured to provide a network resource. The provider network node is further configured to, if the connecting device requests access to the network resource provided by the provider network node, grant the connecting device access to the network resource provided by the provider network node only on the condition that the blockchain stores a first predetermined number of confirmed connection transactions that are authorized by the trusted backbone, indicative of the connecting device and descriptive of the right of the connecting device to access the network resource provided by the provider network node. Here, the first predetermined number is one or greater.

The provider network node may be, for example, a network node formed by a control unit in the industrial network. The network resource provided by the provider network node may be a service that allows the connecting device to perform control operations with and/or read status data from the control unit. The provider network node may also be, for example, a network node formed by a server computer of the industrial network, and the network resource may also be a web site, a shared directory, a downloadable file or any other network resource that is established to be made available only to certain authorized connecting devices.

The predetermined number may be one if the trusted backbone is configured such that one or more of the trusted network nodes of the trusted backbone all authorize the same connection transaction indicative of the connecting device, or may be greater than one if the trusted backbone is configured such that one or more of the trusted network nodes each authorize a separate connection transaction indicative of the connecting device.

The right to access the network resource provided by the provider network node is an example of the right to access the industrial network. A respective connection transaction may be indicative of the right to access the network resource provided by the provider network node by comprising access right data. The access right data may specify an identifier of the network resource provided by the provider network node and may further specify an access right, such as the right to read and/or to write from the network resource. In one embodiment, the access right data may be an Access Control List (ACL).

In accordance with a further embodiment, a respective connection transaction is indicative of the connecting device by comprising identification information of the connecting device.

“A respective connection transaction”, as used herein, is used to refer to either an unconfirmed connection transaction, or a confirmed connection transaction of the first predetermined number of confirmed connection transactions, or both.

At least the provider network node of the plurality of network nodes is configured to determine the identity of the connecting device by verifying identity information transmitted by the connecting device based on the identification information comprised by the respective connection transaction, where the respective connection transaction may be a confirmed connection transaction of the first predetermined number of confirmed connection transactions.

The identity information may be data that is suitable to unambiguously identify the connecting device. The identity information may, for example, be a hardware address that is difficult to counterfeit, or cryptographic information transmitted by the connecting device. In order to verify the identity information, the provider network node may compare the identity information with identification information comprised by the connection transactions stored by the blockchain, or perform a verification algorithm on the identity information and the identification information to determine the identity of the connecting device.

The provider network node may determine the identity of the connecting device in the manner described above when the connecting device requests access to the network resource provided by the provider network node, and only grant access if the identity of the connecting device is successfully determined.

In accordance with a further embodiment, the industrial network further comprises a trusted certification authority. The identification information of the connecting device comprised by the connection transaction indicative of the connecting device comprises a digital certificate comprising a public key of the connecting device and being signed by the trusted certification authority, and the identity information transmitted by the connecting device may comprise a digital signature.

A trusted certification authority or CA is a unit that is configured to sign digital certificates, where the digital certificates signed by the CA are trusted by the plurality of network nodes. A respective digital certificate may include an identifier, a public key, and a signature by the CA.

In the present embodiment, the provider network node may determine the identity of the connecting device in the following way: The provider verifies the digital signature comprised by the identity information transmitted by the connecting device using the public key of the connecting device comprised by the digital certificate included in the connection transaction indicative of the connecting device. This verification will only give an affirmative result if the digital signature has been created by the connecting device using a private key secretly stored in and known only to the connecting device, where the private key is the same private key that has previously been used in generating the digital certificate.

In this way, the identity of the connecting device is determined in a cryptographic manner, thus further enhancing the security of computational access control in the industrial network.

In accordance with a further embodiment, the trusted backbone is configured to authorize the unconfirmed transaction by each of a second predetermined number of the trusted network nodes of the trusted backbone adding a digital signature to the unconfirmed transaction. Herein, a confirmed transaction of the plurality of confirmed transactions is a confirmed transaction that is authorized by the trusted backbone if it comprises the digital signatures of at least the second predetermined number of the trusted network nodes of the trusted backbone. Here, the second predetermined number may be one or greater.

In the present embodiment, the trusted backbone is configured to digitally sign the unconfirmed connection transaction. In this way, the plurality of network nodes can determine whether the unconfirmed connection is authorized by the trusted backbone when reaching the consensus to add the unconfirmed transaction to the backbone, by verifying the digital signature of the trusted backbone. Similarly, as an additional safeguard against counterfeiting, any of the plurality network nodes, like for example, the provider network node, can also check at a later stage if the confirmed transaction stored by the backbone is authorized by the trusted backbone.

For example, the trusted backbone may only digitally sign the unconfirmed connection transaction if the unconfirmed connection transaction has been initiated by the trusted backbone.

In accordance with a further embodiment, the plurality of confirmed transactions stored by the blockchain further comprise one or more confirmed trusted node identification transactions, where a trusted node identification transaction is indicative of at least one trusted network node and descriptive of a right of the at least one trusted network node to belong to the trusted backbone. The plurality of network nodes are configured, when determining if a respective connection transaction is authorized by the trusted backbone, to determine the trusted backbone by referring to the one or more confirmed trusted node identification transactions stored in the blockchain.

In accordance with the present embodiment, the blockchain is used to store information indicative of the trusted backbone. In this way, the information indicative of the trusted network nodes forming the trusted backbone may be stored in a secure way and safeguarded against manipulation. For example, if a trusted network node of the trusted backbone is configured to authorize a transaction by adding a digital signature to the transaction, then a corresponding trusted node identification transaction may comprise a public key of the trusted network node.

The trusted node identification transaction may have a semantics similar to the semantics of the connection transaction. That is, a trusted node identification transaction may be indicative of a trusted network node in the same way as a connection transaction is indicative of a connecting device, such as by comprising a digital certificate of the trusted network node comprising the public key of the trusted network node. The trusted node identification transaction may further be descriptive of a right of the trusted network node to be part of the trusted backbone. The right to be part of the trusted backbone is a further example of the right to access the industrial network. For example, the trusted node identification transaction may comprise an Access Control List (ACL) that includes a flag indicating that the network node indicated by the trusted node identification transaction is a trusted network node.

In accordance with a further embodiment, the connecting device comprises a network node that, when joined to the industrial network, is configured to become one of the network nodes forming the industrial network. Further, each network node of the plurality of network nodes comprises a digital wallet. The plurality of network nodes are further configured to allow transfer of cryptocurrency among each other by exchanging among each other an unconfirmed cryptocurrency transaction and adding the unconfirmed cryptocurrency transaction to the blockchain as a confirmed cryptocurrency transaction of the plurality of confirmed transactions. Herein, the cryptocurrency transaction is a transaction specifying the transfer of an amount of cryptocurrency from the digital wallet of a remitting network node of the plurality of network nodes to the digital wallet of a beneficiary network node of the plurality of network nodes.

In other words, in accordance with the present embodiment, the industrial network implements a cryptocurrency system on top of the blockchain hosted by the plurality of network nodes. The semantics of the cryptocurrency may be a semantics that is adapted to the requirements in an industrial network system. For example, an amount of cryptocurrency may enable the node owning the amount of cryptocurrency to access a network resource provided in the industrial network for a specific number of times corresponding to the amount of cryptocurrency. In this way, cryptocurrency may be used to implement quotas for the use of the industrial network system.

In accordance with a further embodiment, a cryptocurrency transaction specifying the transfer of an amount of cryptocurrency from a remitting network node to a beneficiary network node may comprise an output and may further comprise an input. The output may be data comprised by the cryptocurrency transaction that specifies the amount of cryptocurrency and a public key of the beneficiary network node of the cryptocurrency transaction. The input may be data comprised by the cryptocurrency transaction that comprises a reference to a referenced funding output that is an output comprised by a previous cryptocurrency transaction that is used to fund the cryptocurrency transaction, and a digital signature created using a private key of the remitting network node of the cryptocurrency transaction.

The term “output” could be seen as a “credit note” and the term “input” could be seen as a “debit note” in classical financial terminology.

For example, an output that is referenced by an input comprised by a confirmed cryptocurrency transaction stored by the blockchain is a spent output that has already been spent. Conversely, an output comprised by a cryptocurrency transaction stored by the blockchain that is not referenced by any of the inputs comprised by the confirmed cryptocurrency transactions stored by the blockchain is an unspent output that has previously received a cryptocurrency amount by a previous confirmed cryptocurrency transaction, but has not yet been spent. In this way, the blockchain may store a collection of unspent outputs.

The plurality of network nodes may be further configured to reach the consensus to add an unconfirmed cryptocurrency transaction to the blockchain as a confirmed transaction of the plurality of confirmed transactions only on the condition that the input of the unconfirmed cryptocurrency transaction comprises a reference to an unspent referenced funding output to fund the transaction, and that the digital signature comprised by the input can be verified by using the public key stored in the unspent referenced funding output.

In this way, having access to the private key associated with the public key stored in the unspent output enables the remitting network node to successfully reference the unspent output in an input of a cryptocurrency transaction created by the remitting network node.

A digital wallet may be a digital container configured to store a plurality of private keys, where each private key is associated with a corresponding public key, where the public key is a public key that is comprised by an unspent output stored in the blockchain. In this way, the private keys stored in the digital wallet allow the network node comprising the digital wallet to dispose of the cryptocurrency amounts specified by the corresponding unspent outputs stored in the blockchain.

It should be noted that a “private key being associated with a corresponding public key” refers to the fact that the private key and the corresponding public key together constitute a public-private key pair in accordance with an asymmetric public-private cryptographic method. A first network node having access to the private key can create a digital signature, and a second network node having access to the public key can verify the signature, i.e., verify the digital signature has been created by the first network node.

The process to “transfer of an amount of cryptocurrency from the digital wallet of a remitting network node to the digital wallet of a beneficiary network node of the plurality of network nodes” may involve the following steps: The beneficiary network node creates a public-private key pair comprising a public key and a private key, communicates the public key to the remitting network node, and stores the private key in the digital wallet of the beneficiary network node. The remitting network node creates an unconfirmed cryptocurrency transaction. The unconfirmed cryptocurrency transaction comprises an input which references an unspent output at the disposal of the remitting network node, i.e., an unspent output comprising a public key that is associated with a private key comprised by the digital wallet of the remitting network node, and uses the private key to add a digital signature to the input. The unconfirmed cryptocurrency transaction further comprises an output that specifies the amount of cryptocurrency and comprises the public key received from the beneficiary network node. The remitting network node then exchanges the unconfirmed cryptocurrency transaction with other network nodes of the plurality of network nodes. After one of the mining network node creates a block comprising the unconfirmed cryptocurrency transaction, and the plurality of network nodes reach the consensus to add the block comprising the unconfirmed cryptocurrency transaction to the blockchain, the unconfirmed cryptocurrency transaction becomes a confirmed cryptocurrency transaction, the output comprised by the confirmed cryptocurrency transaction becomes an unspent output at the disposal of the beneficiary network node, the digital wallet of which comprises the private key associated with the unspent output, and the output referenced by the input of the confirmed cryptocurrency transaction becomes a spent output that is no longer at the disposal of the remitting network node.

A digital wallet “containing” or “storing” an amount of cryptocurrency, and/or a network node “having” or “owning” an amount of cryptocurrency”, therefore, as used herein, actually refers to the digital wallet of the network node comprising one or more private keys that allow the network node that includes the digital wallet to dispose of one or more unspent outputs stored in the blockchain, the one or more unspent outputs specifying, in sum, the amount of cryptocurrency, in the manner described above.

It should be further noted that a cryptocurrency transaction may not comprise an input. The cryptocurrency transaction not comprising an input is a so-called “coinbase transaction”, which is used to create the amount of cryptocurrency specified by the coinbase transaction.

In an embodiment, the plurality of network nodes may be further configured to reach the consensus to add the coinbase transaction to the blockchain as a confirmed transaction of the plurality of confirmed transactions only on the condition that the candidate block to be added to the blockchain that comprises the coinbase transaction comprises no further coinbase transaction, and that the coinbase transaction specifies a predetermined reward. The predetermined reward is an amount of currency that is newly created and that the miner network node having formed the candidate block transfers to itself as a reward for the resources allocated, used or spent by the mining network node in forming the candidate block.

In an alternative embodiment, the plurality of network nodes may be configured not to reach the consensus to add any coinbase transaction to the blockchain after the industrial network has been deployed in the field. In this way, the amount of cryptocurrency available in the industrial network is limited to a predetermined maximum amount.

The features of the present embodiment allow the secure operation of a cryptocurrency system in the industrial network, in which double spends are avoided and the current state of ownership of cryptocurrency amounts is safely represented in the blockchain without requiring a central clearing house.

In accordance with a further embodiment, the trusted backbone is configured to, upon authorizing the unconfirmed connection transaction, transfer a first predetermined amount of cryptocurrency from the digital wallet of at least one of the trusted network nodes of the trusted backbone to the digital wallet of the network node of the connecting device indicated by the unconfirmed connection transaction. The provider network node is configured to grant the connecting device access to the network resource provided by the provider network node only on the further condition that a second predetermined amount of cryptocurrency is transferred from the digital wallet of the network node of the connecting device to the digital wallet of the provider network node. The second predetermined amount of cryptocurrency is lesser than or equal to the first predetermined amount of cryptocurrency. In accordance with the present embodiment, it is possible to enforce quotas for accessing the network resource provided by the provider network node. The trusted backbone may grant limited or “quoted” access to a connecting device by initiating and authorizing a connection transaction indicative of the connecting device and descriptive of its right to access the network resource. After that, the trusted backbone may transfer the first predetermined amount of cryptocurrency to the digital wallet of the connecting device, thus effectively assigning a quota or number of allowed accesses to the connecting device. Each time the connecting device seeks to access the network resource provided by the provider network node, the connecting device will only be granted access by the provider network node, if it transfers the second predetermined amount of cryptocurrency, which is smaller than the first predetermined amount of cryptocurrency, to the provider network node. Once the digital wallet of the connecting device is exhausted, the connecting device can no longer access the network resource. The connecting device may then be re-authorized by the trusted backbone, which comprises again transferring an amount of cryptocurrency to the digital wallet of the network node of the connecting device, in order for the connecting device to be able continue to access the network resource.

In accordance with a further embodiment, the trusted backbone is further configured to authorize the unconfirmed cryptocurrency transaction only on the condition that the remitting network node or the beneficiary node is a trusted network node of the trusted network nodes of the trusted backbone, or that the beneficiary node is the provider network node. The plurality of network nodes are further configured to reach the consensus to add an unconfirmed cryptocurrency transaction to the blockchain as a confirmed cryptocurrency transaction of the plurality of confirmed transactions only on the condition that the unconfirmed cryptocurrency transaction is authorized by the trusted backbone.

In accordance with the present embodiment, the circulation of cryptocurrency within the industrial network can be controlled. In particular, a connecting device can be prevented to transfer cryptocurrency to another, potentially malicious, connecting device.

It is also an object to provide an industrial control system comprising an industrial network in accordance with the disclosed embodiments, an industrial facility and a plurality of control units, where each of the control units comprise a network node of the plurality of network nodes. A network node of a respective control unit is a provider network node configured to provide a network resource allowing, when accessed, the performance of a control operation on the industrial facility.

In this way, the features of the industrial network of the first aspect can be advantageously used to control and enforce quotas for the access to the control units of the industrial facility.

The embodiments and features in accordance with the industrial network are also embodiments of the industrial control system.

In accordance with a further embodiment of the industrial control system, the industrial facility is a shunting yard comprising a plurality of railroad switches. Each railroad switch is associated with one of the control units. The control operation comprises an operation to change a position of the railroad switch and/or an operation to read a status of the railroad switch.

A shunting yard is a facility used to sort railway cards in a specific way. In accordance with the present embodiment, an intruder who has managed to join a personal computer to the industrial network by going to a railroad switch and connecting the personal computer to a cable running near the railroad switch can be effectively prevented from wreaking havoc unto the railway operation of the shunting yard.

It is also an object of the invention to provide an access control method for an industrial network comprising a plurality of network nodes being interconnected is proposed. The access control method comprises hosting a blockchain on the plurality of network nodes, where the blockchain is a distributed permissionless trusted database configured to store a plurality of confirmed transactions; forming a trusted backbone of the industrial network from network nodes included by the plurality of network nodes authorizing an unconfirmed connection transaction by the trusted backbone; exchanging the unconfirmed connection transaction among the plurality of network nodes; and adding the unconfirmed transaction to the blockchain as a confirmed connection transaction of the plurality of confirmed transactions only on the condition that a consensus determined by a consensus protocol of the blockchain is reached between the plurality of network nodes, where the confirmed connection transaction is indicative of a connecting device and descriptive of a right of the connecting device to access the industrial network.

In accordance with an embodiment of the method, the access control method for an industrial network further comprises providing a network resource by a provider network node comprised by the plurality of network nodes; and, if the connecting device requests access to the network resource provided by the provider network node; and granting the connecting device access to the network resource provided by the provider network node only on the condition that the blockchain stores a first predetermined number of confirmed connection transactions that are authorized by the trusted backbone, indicative of the connecting device and descriptive of the right of the connecting device to access the network resource provided by the provider network node, where the first predetermined number is one or greater.

In accordance with a further embodiment of the method, the access control method for an industrial network further comprises transferring a first predetermined amount of cryptocurrency from a digital wallet of at least one of the trusted network nodes of the trusted backbone to a digital wallet of a network node of the connecting device indicated by the unconfirmed connection transaction; and granting the connecting device access to the network resource provided by the provider network node only on the further condition that a second predetermined amount of cryptocurrency is transferred from the digital wallet of the network node of the connecting device to the digital wallet of the provider network node, where the second predetermined amount of cryptocurrency is lesser than or equal to the first predetermined amount of cryptocurrency.

It is also an object of the invention to provide a computer program product (i.e., a non-transitory computer-readable medium), where the computer program product comprises a program code for executing the method in accordance with the invention or an embodiment of the method when the program code is executed on at least one computer.

A computer program product, such as a computer program means, may be formed as a memory card, USB stick, CD-ROM, DVD or as a file which may be downloaded from a server in a network. For example, such a file may be provided by transferring the file comprising the computer program product from a wireless communication network.

Further possible implementations or alternative solutions of the invention also encompass combinations—that are not explicitly mentioned herein—of features described above or below with regard to the embodiments. The person skilled in the art may also add individual or isolated aspects and features to the most basic form of the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Further embodiments, features, and advantages of the present invention will become apparent from the subsequent description and dependent claims, taken in conjunction with the accompanying drawings, in which:

FIG. 1 shows a schematic diagram of an industrial network in accordance with a first embodiment;

FIG. 2 shows a schematic diagram of an industrial control system including an industrial facility and an industrial network in accordance with a second embodiment;

FIG. 3 shows a schematic diagram of the semantics of a connection transaction in accordance with the second embodiment of FIG. 2;

FIG. 4 shows a schematic diagram of an industrial control system including an industrial facility and an industrial network in accordance with a third embodiment;

FIG. 5 illustrates an access control method for an industrial network in accordance with an embodiment;

FIG. 6 illustrates an access control method for an industrial network in accordance with a further embodiment; and

FIG. 7 illustrates an access control method for an industrial network in accordance with yet a further embodiment.

### DETAILED DESCRIPTION OF THE EXEMPLARY EMBODIMENTS

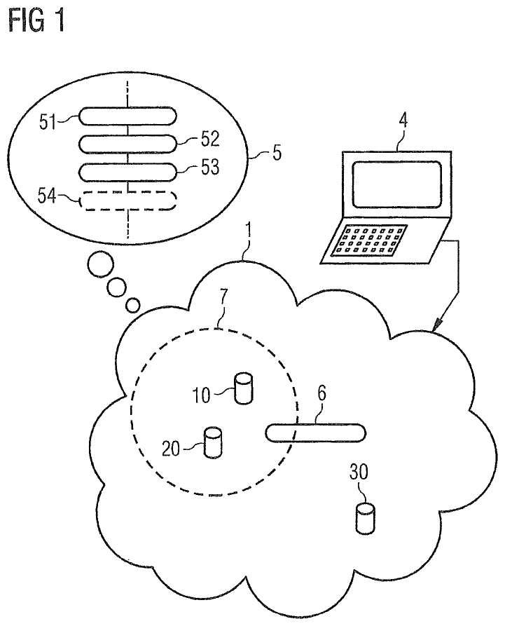

In the Figures, like reference numerals designate like or functionally equivalent elements, unless otherwise indicated. FIG. 1 shows an industrial network 1 in accordance with a first embodiment. The industrial network 1 comprises a first network node 10, a second network node 20 and a third network node 30. The industrial network 1 is shown as a cloud in order to illustrate that the plurality of network nodes 10, 20 and 30 may be interconnected in any suitable topology.

The plurality of network nodes 10, 20, 30 of the industrial network 1 host a blockchain 5. The blockchain 5 comprises a plurality of confirmed transactions 51, 52, 53, . . . . The blockchain 5 stores the plurality of confirmed transactions 51, 52, 53, . . . in a chain of blocks (not illustrated). Each block comprises at least one of the plurality of confirmed transactions 51, 52, 53, . . . and is linked to its preceding block using a hash value of the preceding block as a reference value. Each of the plurality of network nodes 10, 20, 30 comprises a storage (not illustrated) and stores a local copy of the chain of blocks in the storage.

When a new transaction is to be added to the blockchain 5, one of the network nodes, such as network node 10, creates an unconfirmed transaction 6. The unconfirmed transaction 6 is then passed on or exchanged among the network nodes 10, 20, 30 in a peer-to-peer manner.

The network nodes 10, 20, 30 treat the unconfirmed transaction 6 in accordance with a consensus protocol in order to reach a consensus to add the unconfirmed transaction 6 to the blockchain 5 in the following way:

For example, network node 20 may be configured as a mining network node. Network node 20 comprises a memory (not illustrated) and stores the unconfirmed transaction 6 in the memory together with further unconfirmed transactions that are exchanged among the network nodes 10, 20, 30. Network node 20 then performs operations in order to determine a nonce value that, when combined with the unconfirmed transactions stored in the memory and with a hash value of the currently last block in the blockchain 5, will yield a new block that fulfills a validity criterion mandated by the consensus protocol. For example, the consensus protocol mandates that the hash value of the new block be lower than a predetermined value. The determination of a proper nonce value is computationally difficult and takes time. If the network node 20 manages to create a new block that is valid under the consensus protocol before any other of the network node 10, 20, 30 manages to do so, then network node 20 adds the new block to its local chain of blocks (copy of the blockchain 5) and exchanges the new block among the network nodes 10, 20, 30 in a peer-to-peer-manner. The other network nodes 20, 30, upon seeing the new block, verify the new block in accordance with the consensus protocol and add the new block to their respective copies of the blockchain 5. In this way, the unconfirmed transaction 6 is added to the blockchain 5 as the confirmed transaction 54.

It is noted that the blockchain is not only distributed, but also permissionless, i.e., further network nodes may be joined to the industrial network 1 and begin to participate in hosting the blockchain 5 without having to supply any credentials. However, the consensus protocol makes it prohibitively difficult in terms of the required computational resources to manipulate the contents of the blockchain.

FIG. 1 further shows a connecting device 4. The connecting device 4 may be a laptop. The laptop 4 is seeking to access the industrial network 1. While the consensus protocol protects the blockchain 5 against manipulation by the laptop 4, it should be appreciated that there is a necessity to ensure the laptop 4 actually has the right to access field automation functionality that is provided by the industrial network 1. The industrial network 1 therefore comprises a database defining access rights of the industrial network 1. In accordance with the present embodiment, the blockchain 5 is used as the database defining the access rights in the industrial network 1.

The blockchain 5 comprises, among the confirmed transactions 51, 52, 53, 54, a confirmed connection transaction 52. The confirmed connection transaction 52 comprises data that is indicative of the connecting device 4 and further comprises data describing the right of the connecting device 4 to access the industrial network 1.

As described above, the blockchain 5 is configured to make it prohibitively difficult to manipulate the confirmed connection transaction 52.

The industrial network 1 comprises a trusted backbone 7. The trusted backbone 7 comprises the first network node 10, which is a first trusted network node, and the second network node 20, which is a second trusted network node, but does not comprise the third network node 30. The trusted backbone 7 may be located in a safe room, and access to the trusted backbone 7 may be restricted to trusted operators.

The confirmed connection transaction 52 is a transaction that has been authorized by the trusted backbone 7.

In this way, each network node 10, 20, 30 of the industrial network 1 can determine the right of the connecting device 4 to access the industrial network 1 by checking the blockchain 5, i.e., its respective local chain of blocks, for the existence of the confirmed connection transaction 52 that is authorized by the trusted backbone 7. Due to the specific characteristics of the blockchain 5 and the associated consensus protocol, this determination is highly reliable and resilient even if a malicious network node is connected to the industrial network 1 and also even in the absence of full network connectivity.

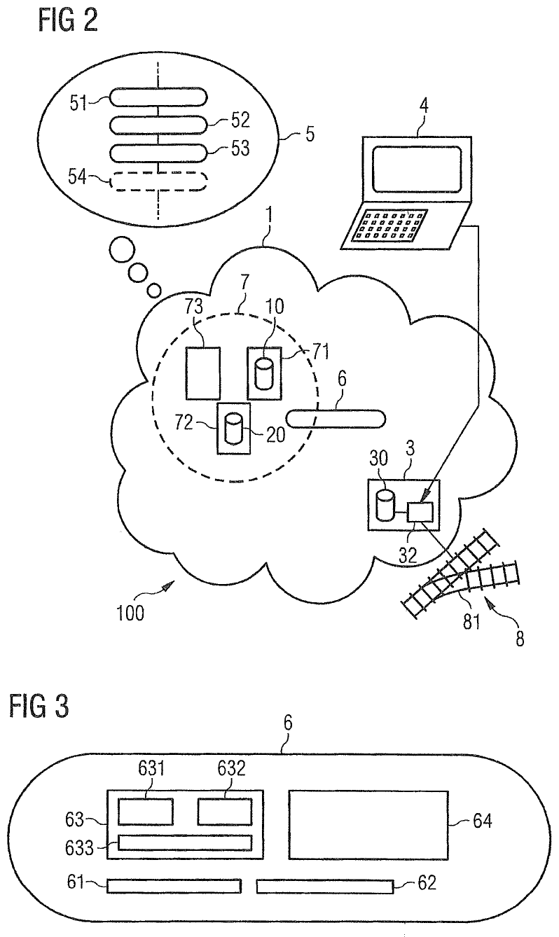

The unconfirmed transaction 6 shown in FIG. 2 may be an unconfirmed connection transaction 6. The consensus rule of the blockchain 5 of the industrial network 1 mandates that the plurality of network nodes 10, 20, 30 will add a new block comprising the unconfirmed connection transaction 6 to the blockchain 5, whereby the unconfirmed connection transaction 6 becomes a confirmed connection transaction of the plurality of confirmed transactions 51, 52, 53, 54, only on the condition that the unconfirmed connection transaction 6 has been authorized by the trusted backbone 7.

FIG. 2 shows a schematic diagram of an industrial control system 100 including an industrial facility 8, a control unit 3 and an industrial network 1 in accordance with a second embodiment.

The industrial facility 8 is a shunting yard comprising a plurality of railroad switches. One railroad switch of the railroad switches is illustrated at 81.

The control unit 3 is associated with the railroad switch 81 and forms the network node 30. The network node 30 is a provider network node providing access to a network resource 32. The network resource 32 is a website, an API or a network port that allows, when accessed, to perform a control operation on the shunting yard using the control unit 3. In particular, the network resource 32 may be read so as to read a switch status or position of the railroad switch 81. The network resource 32 may be written to so as to change a switch position of the railroad switch 81.

If the laptop 4 requests access to the network resource 32, then the provider network node 30 will check the blockchain 5 for the existence of a predetermined number of confirmed transaction connections 52 that are authorized by the trusted backbone 7, are indicative of the laptop 4 and are descriptive of the right of the laptop 4 to access the network resource 32. The predetermined number is one in the present embodiment. However, in an embodiment, the predetermined number may also be any number up to the number of trusted network nodes 10, 20 of the trusted backbone 7, i.e., the predetermined number could also be 2 (two) in the present embodiment. The provider network node 30 will then only grant access to the network resource 32 for the connecting device 4 if the confirmed connection transaction 52 (the predetermined number of confirmed connection transactions) is/are present in the blockchain 5.

In FIG. 2, the trusted backbone 7 of the industrial network 1 comprises a first server computer 71, a second server computer 72 and a third server computer 73. The first server computer 71 forms the first trusted network node 10. The second server computer 72 forms the second trusted network node 20. The third server computer 73 forms a trusted certificate authority (CA).

FIG. 3 shows a schematic diagram to illustrate the semantics of a connection transaction 6. In particular, FIG. 3 shows the semantics of the unconfirmed connection transaction 6 of FIGS. 1, 2. However, the same semantics may also apply to the confirmed connection transaction 52 of FIGS. 1, 2. In the following, reference will therefore be made collectively to the “connection transaction 6, 52”.

The connection transaction 6, 52 is indicative of the connecting device 4 in the following way: The connection transaction 6, 52 comprises identification information 63. The identification information 63 comprises data that is adapted to be used to identify the connecting device 4. In the present embodiment, the identification information 63 is a digital certificate of the connecting device 4. The digital certificate 63 comprises a public key 631 of the connecting device 4, an identifier 632 of the connecting device 4 and a digital signature 633 created by the trusted certificate authority 7.

For example, the provider network node 30 determines whether the confirmed connection transaction 52 is indicative of the connecting device 4 by comparing an identifier transmitted, as part of identity information, by the connecting device 4 with the identifier 632 comprised by the identification information 63, by verifying a digital signature transmitted, as part of the identity information, by the connecting device 4 using the public key 631 of the connecting device 4 comprised by the digital certificate 63, and by verifying the digital signature 633 comprised by the digital certificate 63 using a public key (not shown) of the trusted certificate authority 73, which may be pre-stored in the provider network node 30 and/or in the blockchain 5. If all three verifications are affirmative, the confirmed connection transaction 52 is determined to be indicative of the connecting device 4.

The connection transaction 6, 52 is descriptive of the right of the connecting device 4 to access the industrial network 1 in the following way: The connection transaction 6, 62 comprises rights data 64, which comprise an access control list (ACL) describing the access rights of the connecting device 4.

The connection transaction 6, 52 is authorized by the trusted backbone 7, e.g., in the following way: When a new connection device is to be authorized, the trusted network node 10 creates, e.g., under operation by an authorized operator, the unconfirmed connection transaction 6. The first trusted network node 10 adds a first digital signature 61 of the first trusted network node 10 to the unconfirmed connection transaction 6 and exchanges the unconfirmed transaction connection 6 with other the other network nodes 20, 30 in a peer-to-peer manner. When the second trusted network node 20 sees the unconfirmed connection transaction 6 and sees the digital signature 61 of the first trusted network node 20, the second trusted network node 20 adds a second digital signature 62 of the second trusted network node 20 to the unconfirmed connection transaction 6.

When the unconfirmed connection transaction 6 is added to the blockchain 5 by a mining network node of the network nodes 10, 20, 30, the respective mining network node verifies the digital signature 61 of the first trusted network node 10 using a public key of the first trusted network node 10, and verifies the digital signature 62 of the second trusted network node 20 using a public key of the second trusted network node 20 to determine whether the unconfirmed connection transaction 6 is authorized by the trusted backbone 7.

The blockchain 5 comprises a confirmed trusted node identification transaction 51 that comprises the public key of the trusted network node 10. Similarly, the blockchain 5 further comprises a confirmed trusted node identification transaction (not shown) comprising the public key of the trusted network node 20. The confirmed trusted node identification transactions have a semantics similar to the connection transaction, i.e., the confirmed trusted node identification interaction is indicative of the trusted network node 10 by comprising a digital certificate of the trusted network node 10. The mining network node refers to the confirmed trusted node identification transactions stored in the blockchain 5 to determine the trusted backbone 7, i.e., determine the digital certificates of the trusted network nodes 10, 20, which comprise the respective public keys of the trusted network nodes 10, 20.

The confirmed trusted node identification transaction 51 may be pre-stored in the blockchain 5 before the industrial network 1 is deployed in the field.

It is also noted that any of the network node 10, 20, 30 can verify the authorization by the trusted backbone 7 of the confirmed connection transaction 52 in the same way as the mining network node can verify the authorization by the trusted backbone 7 of the unconfirmed connection transaction 6.

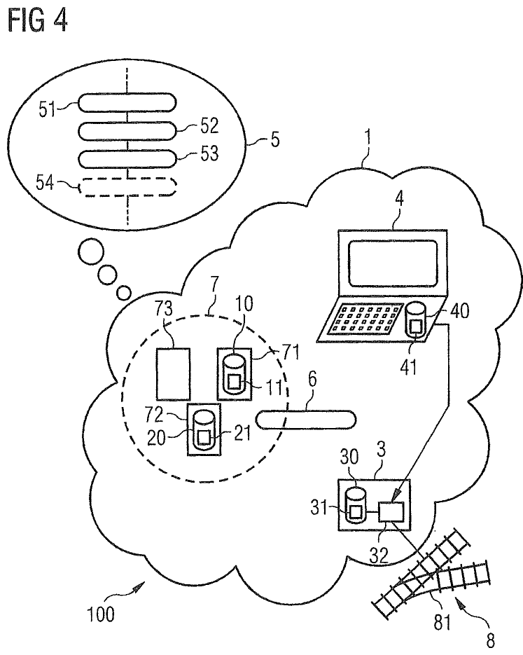

FIG. 4 shows a schematic diagram of an industrial control system including an industrial facility and an industrial network in accordance with a third embodiment.

In FIG. 4, each of the network nodes 10, 20, 30 further comprises a respective first digital wallet 11, second digital wallet 22, and third digital wallet 31. The laptop 4 further comprises a fourth network node 40. In other words, the laptop 4 comprises therein a network node 40 that, upon joining the laptop 4 to the industrial network, becomes one of the network nodes 10, 20, 30, 40 forming the industrial network 1 and hosting the blockchain 5. The fourth network node 40 further comprises a fourth digital wallet 41.

The unconfirmed transaction 6 shown in FIG. 4 may, in addition to the unconfirmed connection transaction, also represent an unconfirmed cryptocurrency transaction. In other words, the network nodes 10, 20, 30, 40 of the third embodiment are configured to exchange among each other both unconfirmed connection transactions and unconfirmed cryptocurrency transactions. Likewise, the blockchain 5 of FIG. 4 stores the confirmed connection transaction 52, but also stores a confirmed cryptocurrency transaction 53.

A remittent network node of the network nodes 10, 20, 30, 40, can transmit an amount of cryptocurrency from its respective digital wallet 11, 21, 31, 41 to the digital wallet 11, 21, 31, 41 of a beneficiary network node of the network nodes 10, 20, 30, 40 by creating an unconfirmed cryptocurrency transaction 6 and exchanging the unconfirmed cryptocurrency transaction 6 among the network nodes 10, 20, 30, 40. The consensus protocol of the blockchain 5 determines that the unconfirmed cryptocurrency transaction 6 will be added to the blockchain 5 only on the condition that the digital wallet 11, 21, 31, 41 of the remitting network node of the network nodes 10, 20, 30, 40 contains the proper amount of cryptocurrency.

The trusted backbone 7 is pre-configured to have a large amount of cryptocurrency in the digital wallets 11, 21 of the trusted network nodes 10, 20.

After the trusted backbone 7 authorizes an unconfirmed connection transaction 6 by adding the digital signature 61 to the unconfirmed connection transaction 6 (FIG. 3), the trusted backbone 7, i.e., one of the trusted nodes 10, 20, transmits a first predetermined amount of cryptocurrency from its digital wallet 11, 21 to the digital wallet 41 of the network node 40 of the connecting device 4 indicated by the unconfirmed connection transaction 6. That is, after having been authorized, the connecting device 4 (the laptop 4) can dispose of the first predetermined amount of cryptocurrency in its wallet 41.

When requesting access to the network resource 32 provided by the provider network node 30, the laptop 4 transfers a second predetermined amount, which is a fraction of the first predetermined amount, of cryptocurrency from its digital wallet 41 to the digital wallet 31 of the provider network node 30. The provider network node 30 of FIG. 4, in addition to checking whether the blockchain 5 comprises the confirmed connection transaction 5 indicative of the laptop 4, also checks whether the laptop 4 has transferred the second predetermined amount of cryptocurrency into the digital wallet 31 of the provider node 30, and grants access to the network resource 32 only if the second predetermined amount of cryptocurrency has been transferred by the laptop 4.

In this way, a quota is applied for accessing the network resource 32, i.e., the laptop 4 can only access the network resource 32 a certain number of times. Once the cryptocurrency stored in the digital wallet 41 of the fourth network node 40 of the laptop 4 is exhausted, the laptop 4 will not be able to continue to access the network resource 32. The user of the laptop 4 can then see an authorized maintenance operator and request the transfer of a further first predetermined amount of cryptocurrency.

In an embodiment of the third embodiment, the industrial network enforces restrictions on the transfer of cryptocurrency established to prevent abuse of the cryptocurrency. The consensus protocol of the blockchain 5 mandates that an unconfirmed cryptocurrency transaction 6 will only be added to the blockchain 5 if it is authorized by the trusted backbone 7. Authorization of a cryptocurrency transaction 6 happens in a similar way to the authorization of a connection transaction 6, i.e., by adding digital signatures 61, 62 of the trusted network nodes 10, 20. The trusted backbone 7 is configured to only authorize cryptocurrency transactions 6, 53 that involve either a network node 10, 20 of the trusted backbone 7 as a remitting or beneficiary network node, or involve the provider network node 30 as a beneficiary network node. In this way, a second connecting device (not shown) is prevented from sending cryptocurrency to the laptop 4 and vice versa.

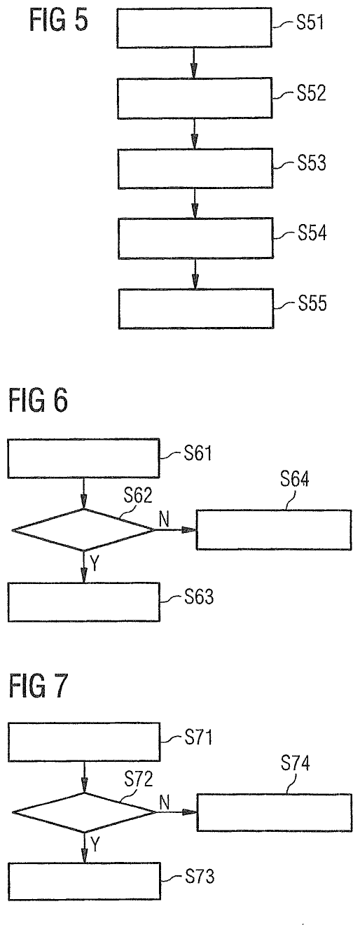

FIG. 5 illustrates an access control method for an industrial network in accordance with an embodiment.

In step S51, the blockchain 5 is set up to be hosted on the plurality of network nodes 10, 20, 30.

In step S52, the trusted backbone 7 is formed from the trusted network nodes 10 and 20.

In step S53, the trusted backbone 7 creates the unconfirmed connection transaction 6, which is indicative of the connecting device 4 and descriptive of a right of the connecting device 5 to access the industrial network 1. The trusted backbone 7 then authorizes the unconfirmed connection transaction 6 created by the trusted backbone 7.

In step S54, the unconfirmed connection transaction 6 is exchanged among the plurality of network nodes 10, 20, 30.

In step S55, the unconfirmed connection transaction 6 is added to the blockchain 5 as a confirmed transaction 52 of the plurality of confirmed transactions 51, 52, 53, 54 only on the condition that a consensus determined by a consensus protocol of the blockchain 5 is reached between the plurality of network nodes 10, 20 30. In particular, the consensus protocol mandates that the unconfirmed connection transaction 6 be authorized by the trusted backbone 7.

FIG. 6 illustrates an access control method for an industrial network in accordance with a further embodiment.

In step S61, the provider network node 30 provides the network resource 32.

In step S62, the provider network node 30 determines whether the blockchain 5 stores a confirmed connection transaction 52 that is authorized by the trusted backbone 7, indicative of the connecting device 4 and descriptive of the right of the connecting device 4 to access the network resource 32 provided by the provider network node 30.

If the determination is affirmative, the provider network node 30 grants the connecting device 4 access to the network resource 32 in step S63. Otherwise, access is denied in step S64.

FIG. 7 illustrates an access control method for an industrial network in accordance with yet a further embodiment.

In step S71, the trusted network node 10 transfers a first predetermined amount of cryptocurrency from its digital wallet 11 to the digital wallet 41 of the network node 40 of the connecting device 4.

In step S72, the provider network node 30 determines if a second predetermined amount of cryptocurrency is transferred into the digital wallet 31 of the provider network node 30 from the digital wallet 41 of the network node 40 of the connecting device 4.

If the second predetermined amount of cryptocurrency has been transferred, then the provider network node 30 grants the connecting device 4 access to the network resource 32 provided by the provider network node 30 at step S73. Otherwise, access is denied at step S74.

Although the present invention has been described in accordance with preferred embodiments, it is obvious for the person skilled in the art that modifications are possible in all embodiments.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. An industrial network comprising:
a plurality of interconnected network nodes, each of said plurality of interconnected network nodes being configured to:
host a blockchain, the blockchain being a distributed permissionless trusted database configured to store a plurality of confirmed transactions and exchange an unconfirmed transaction among each other; and
add an unconfirmed transaction to the blockchain as a confirmed transaction of the plurality of confirmed transactions only on a condition that a consensus determined by a consensus protocol of the blockchain is reached between the plurality of network nodes;
wherein the plurality of network nodes include a plurality of trusted network nodes forming a trusted backbone of the industrial network; and
wherein the plurality of confirmed transactions stored by the blockchain comprise a confirmed connection transaction which is authorized by the trusted backbone, is indicative of a connecting device and is descriptive of a right of the connecting device to access the industrial network.

17. The industrial network of claim 16, wherein the unconfirmed transaction is an unconfirmed connection transaction;
wherein the trusted backbone is configured to authorize the unconfirmed connection transaction; and
wherein the plurality of network nodes are further configured to reach a consensus to add the unconfirmed connection transaction to the blockchain as the confirmed connection transaction of the plurality of confirmed transactions only on a condition that the unconfirmed connection transaction is authorized by the trusted backbone.

18. The industrial network of claim 16, wherein the plurality of network nodes further comprise a provider network node configured to:
provide a network resource; and
grant the connecting device access to the network resource provided by the provider network node only on a condition that the blockchain stores a first predetermined number of confirmed connection transactions, which are authorized by the trusted backbone, indicative of the connecting device and descriptive of the right of the connecting device to access the network resource provided by the provider network node, if the connecting device requests access to the network resource provided by the provider network node;
wherein the first predetermined number is one or greater.

19. The industrial network of claim 17, wherein the plurality of network nodes further comprise a provider network node configured to:
provide a network resource; and
grant the connecting device access to the network resource provided by the provider network node only on a condition that the blockchain stores a first predetermined number of confirmed connection transactions, which are authorized by the trusted backbone, indicative of the connecting device and descriptive of the right of the connecting device to access the network resource provided by the provider network node, if the connecting device requests access to the network resource provided by the provider network node;
wherein the first predetermined number is at least one.

20. The industrial network of claim 18, wherein a respective connection transaction is indicative of the connecting device by comprising identification information of the connecting device; and
wherein at least the provider network node of the plurality of network nodes is configured to determine an identity of the connecting device by verifying identity information transmitted by the connecting device based on identification information comprised of a respective connection transaction.

21. The industrial network of claim 20, further comprising:
a trusted certificate authority;
wherein the identification information of the connecting device comprised of the connection transaction indicative of the connecting device comprises a digital certificate comprising a public key of the connecting device and being signed by the trusted certificate authority; and
wherein the identity information transmitted by the connecting device comprises a digital signature.

22. The industrial network of claim 16, wherein the trusted backbone is configured to authorize the unconfirmed transaction by each of a second predetermined number of trusted network nodes of the trusted backbone adding a digital signature to the unconfirmed transaction; and
wherein a confirmed transaction of the plurality of confirmed transactions comprises a confirmed transaction which is authorized by the trusted backbone if said confirmed transaction comprises the digital signatures of at least a second predetermined number of trusted network nodes of the trusted backbone, the second predetermined number being at least one.

23. The industrial network of claim 16, wherein the plurality of confirmed transactions stored by the blockchain further comprise at least one confirmed trusted node identification transaction;
wherein a trusted node identification transaction is indicative of at least one trusted network node and descriptive of a right of the at least one trusted network node to belong to the trusted backbone;
wherein the plurality of network nodes are configured, when determining whether a respective connection transaction is authorized by the trusted backbone, to determine the trusted backbone by referring to the at least one confirmed trusted node identification transaction stored in the blockchain.

24. The industrial network of claim 16, wherein the connecting device comprises a network node which, when joined to the industrial network, is configured to become a network node of the plurality of network nodes forming the industrial network;
wherein each network node of the plurality of network nodes further comprises a digital wallet;
wherein the plurality of network nodes are further configured to allow transfer of cryptocurrency among each other by exchanging among each other an unconfirmed cryptocurrency transaction and adding the unconfirmed cryptocurrency transaction to the blockchain as a confirmed cryptocurrency transaction of the plurality of confirmed transactions; and
wherein the cryptocurrency transaction comprises a transaction specifying a transfer of an amount of cryptocurrency from a digital wallet of a remitting network node of the plurality of network nodes to a digital wallet of a beneficiary network node of the plurality of network nodes.

25. The industrial network of claim 24, wherein the trusted backbone is configured to, upon authorizing the unconfirmed connection transaction, transfer a predetermined amount of cryptocurrency from the digital wallet of at least one of the trusted network nodes of the trusted backbone to a digital wallet of the network node of the connecting device indicated by the unconfirmed connection transaction and the provider network node is configured to grant the connecting device access to the network resource provided by the provider network node only on the further condition that a second predetermined amount of cryptocurrency is transferred from the digital wallet of the network node of the connecting device to the digital wallet of the provider network node,
wherein the second predetermined amount of cryptocurrency being less than or equal to the first predetermined amount of cryptocurrency.

26. The industrial network of claim 24, wherein the trusted backbone is further configured to authorize the unconfirmed cryptocurrency transaction only on a condition that one of (i) the remitting network node and (ii) the beneficiary node comprises one of a trusted network node of the trusted network nodes of the trusted backbone and the beneficiary node is the provider network node; and
wherein the plurality of network nodes are further configured to reach a consensus to add an unconfirmed cryptocurrency transaction to the blockchain as a confirmed cryptocurrency transaction of the plurality of confirmed transactions only on a condition that the unconfirmed cryptocurrency transaction is authorized by the trusted backbone.

27. The industrial network of claim 25, wherein the trusted backbone is further configured to authorize the unconfirmed cryptocurrency transaction only on a condition that one of (i) the remitting network node and (ii) the beneficiary node comprises one of a trusted network node of the trusted network nodes of the trusted backbone and the beneficiary node is the provider network node; and
wherein the plurality of network nodes are further configured to reach a consensus to add an unconfirmed cryptocurrency transaction to the blockchain as a confirmed cryptocurrency transaction of the plurality of confirmed transactions only on a condition that the unconfirmed cryptocurrency transaction is authorized by the trusted backbone.

28. An industrial control system comprising the industrial network of claim 16;
an industrial facility; and
a plurality of control units which each of comprise a network node of the plurality of network nodes;
wherein a network node of a respective control unit comprises a provider network node configured to provide a network resource allowing, when accessed, to perform a control operation on the industrial facility.

29. The industrial control system of claim 28, wherein the industrial facility forms a shunting yard comprising a plurality of railroad switches which are each associated with one of the control units; and
wherein the control operation comprises an operation to at least one of (i) change a position of a railroad switch of the plurality of railroad switches and (ii) an operation to read a status of the railroad switch.

30. An access control method for an industrial network comprising a plurality of network nodes being interconnected, the access control method comprising:
hosting a blockchain on the plurality of network nodes, the blockchain being a distributed permissionless trusted database configured to store a plurality of confirmed transactions;
forming a trusted backbone of the industrial network from a number of network nodes included by the plurality of network nodes;
authorizing an unconfirmed connection transaction by the trusted backbone;
exchanging the unconfirmed connection transaction among the plurality of network nodes; and
adding the unconfirmed connection transaction to the blockchain as a confirmed connection transaction of the plurality of confirmed transactions only on a condition that a consensus determined by a consensus protocol of the blockchain is reached between the plurality of network nodes;
wherein the confirmed connection transaction is indicative of a connecting device and descriptive of a right of the connecting device to access the industrial network.

31. The access control method for the industrial network of claim 30, further comprising:
providing a network resource by a provider network node comprised of the plurality of network nodes; and
granting the connecting device access to the network resource provided by the provider network node only on a condition that the blockchain stores a first predetermined number of confirmed connection transactions which are authorized by the trusted backbone, indicative of the connecting device and descriptive of the right of the connecting device to access the network resource provided by the provider network node, if the connecting device requests access to the network resource provided by the provider network node;
wherein the first predetermined number is at least one.

32. The access control method for the industrial network of claim 31, further comprising:
transferring a first predetermined amount of cryptocurrency from a digital wallet of at least one network node of the trusted network nodes of the trusted backbone to a digital wallet of a network node of the connecting device indicated by the unconfirmed connection transaction; and
granting the connecting device access to the network resource provided by the provider network node only on a further condition that a second predetermined amount of cryptocurrency is transferred from the digital wallet of the network node of the connecting device to the digital wallet of the provider network node;
wherein the second predetermined amount of cryptocurrency is lesser than or equal to the first predetermined amount of cryptocurrency.
